(19) United States
(12) Patent Application Publication
(10) Pub. No.: US 2009/0030908 A1
(43) Pub. Date: Jan. 29, 2009

(54) CENTRALIZED MANAGEMENT TYPE COMPUTER SYSTEM

(75) Inventor: Hiroshi Kawabe, Mie (JP)

Correspondence Address: AKERMAN SENTERFITT, P.O. BOX 3188, WEST PALM BEACH, FL, 33402-3188, US

(73) Assignee: IZE CO., LTD., Mie (JP)

(21) Appl. No.: 11/577,122

(22) PCT Filed: Oct. 13, 2005
(86) PCT No.: PCT/JP05/18858

§ 371 Date: Apr. 12, 2007

(30) Foreign Application Priority Data
Oct. 14, 2004 (JP) 2004-299566

(51) Int. Cl. G06F 17/30

(52) U.S. Cl. 707/10; 707/E17.01; 707/E17.032

(57) ABSTRACT

A computer system for an easy system/information management. A client (100) and a server (200) are connected through a network (NW) so that a hard disk (240) or a server storage device is stored with a server holding type application program such as a menu program (243) to be operated on the web browser of the client (100). The server (200) has a web server program (242) and provides a file in response to the request of the client (100). After having started a second OS program (151), the client (100) starts a web browser program (153) in a full-screen display, and gains access to the file which is set for each client (100) or user and expressed in URL.

### TECHNICAL FIELD

The present invention relates to a centralized management type computer system, and particularly, to a computer system that can effectively prevent data leakage with easy system management.

### BACKGROUND ART

Computers have been introduced in a variety of fields for higher work efficiency because computers can easily store and process large amounts of information (data). Particularly, in recent years, computers have explosively been spread due to its high level of functions and reasonable price, and have become indispensable tools for preparing documents in business. Computers are indispensable tools not only for private corporations, but also for information management and information providing services by public agencies.

At the same time, a problem is that computers can copy data of the corporations or data of public agencies; thus, letting the data to be taken out because computers can easily copy large amounts of data.

One major factor in such data leakage is that users can easily connect a large-capacity removable external storage device to computers due to the high level of functions of the computer system. In fact, users are not anxious to be looked by the system administrator, thus can take out large amounts of data.

Conventionally, a technology to prevent information leakage is preformed by encrypting data when transmitted between a server and a client (see Patent document 1, for example).

However, in many actual cases of the information leakage, the insider is the one to take out unauthorized information. Thus, although the information leakage is prevented at the time of communication, it is not enough as a prevention method.

Also, when new computers are to be installed, new software, for example, OS (Operating System) or application software, such as word processors, spreadsheets, etc., needs to be introduced for each new computer. The introduction and the management cost are a heavy burden on the corporations or public agencies.

Though the software installation can easily be done by automation, the software still needs to be installed in each computer, resulting in a very heavy burden on the system administrator. Recently, the software can automatically be upgraded or its malfunction can be corrected through the Internet. However, appropriate upgrading operations may not be done by a user who is not familiar with the computer or by operations of virus-infection preventing software. As a result, different versions of software may exist among terminals within a corporation.

Further, as computers are even more widely used, more damage by the computer virus is predictable. Therefore, it is demanded that the damage by the computer virus is minimized.

Patent Document 1: Japanese Patent Application Laid-Open No. 2002-278970

### DISCLOSURE OF INVENTION

The present invention has been made in consideration of the above background. An object of the present invention is to provide a centralized management type computer system that can effectively prevent information leakage and easily manage information and system.

In order to overcome the above problem, according to the present invention, there is provided a centralized management type computer system including at least one server and at least one client.

The server includes a server CPU (Central Processing Unit), a server storage device and a server communication device, and has a server program executed by the server CPU in the server storage device. The server program includes: a first operating system program; a Web server program which operates on the first operating system program, causes the server to function as a Web server, and sends a file or files stored in one or a plurality of URL and set in the server storage device through the server communication device in response to a request from the client; and various server preserving type application programs which are program files indicated by the URL (Uniform Resource Locator), and realize various applications using a GUI (Graphical User Interface) operating in response to a call by a Web browser on the client.

The client includes a client CPU, a client storage device and a client communication device, and has a client program executed by the client CPU in the client storage device. The client program includes: a second operating system program; a Web browser program which operates on the second operating system program, and it accesses to a file or files stored in a predetermined URL in the server storage device through the client communication device; and an application execution program which is executed in a Web browser window displayed upon execution of the Web browser program, and executes the server preserving type application programs so as to realize the various applications using the GUI.

The client executes a first procedure for starting the second operating system program and a second procedure for starting the Web browser program with the file indicated by the URL serving as an access destination in a full screen display without waiting for a user operation, thereby starting the server preserving type application program(s) indicated by the URL at activation of the client.

According to this computer system, a centralized management type computer system can easily be configured by using a somehow standardized Web browser program, without depending on an operating system (hereafter, referred to as “OS” arbitrarily). On the client, the Web browser program is displayed in a full screen display after starting the second operating system. Thus, the user can use this system that can function as a virtual OS without bothering about the browser.

After it is started, the Web browser program can access to the URL of the server that is set for each client or user, thereby executing applications in the server. At this time, the user cannot at all be aware to which place of the server he/she is access to. Therefore, the user cannot execute an arbitrary program within the server without being authorized.

In the browser of a full screen display, an application which is executed upon calling from the server after its starting time is set as a kind of menu-type program for selecting an application, for example. By doing so, it is possible to limit applications that can be instructed to be executed by the user. If the server preserving type application programs indicated in a predetermined URL in the server can be executed at the time of starting the client, simply by updating the application programs in the server, the server administrator can update programs for each client using.

Also, it is suffices for the applications to be introduced only in the server; thus, withholding the cost for the introduction.

The Web browser program is application software for browsing Web pages in accordance with World Wide Web internet service (WWW). With the software, html (Hyper Text Markup Language) files or image files are downloaded from computers on a network such as the Internet, and their layouts are analyzed so as to display and reproduce the files. URL is a description format specifying a location of information resources such as html files, and may specify directories or file names.

The client storage device includes not only a built-in hard disk, but also removable external storage devices such as a CD-ROM drive, an MO drive, flash memory, etc.

In the present invention, the various applications using the GUI include a file operational application for performing at least a copy operation for a file, and the file operational application is preferably set to be capable of operating a file in a predetermined folder of the server storage device, and is preferably set to be incapable of accessing to a removable external storage device to be connected at least to the client.

This file operational application is meant to be a program for copying and moving data files and also for forming and deleting directories. Operations for copying or moving files are necessary for using a computer. Recently, in general computers, commands of the operating system are designated by the GUI for the operation.

In the computer system of the present invention, only the Web browser program is directly executed on the second operating system, and file operational commands and file operational applications, or the like, of the second operating system can not be used directly. Thus, in the computer system of the present invention, the file operational applications are preferably provided by the server preserving type application programs operating on the Web browser. At this juncture, the file operational applications provided by the server preserving type application programs set as accessible to files in the server storage device, and set as inaccessible to the removable external storage device that can be connected at least to the client. As a result, while general documents in business can be operated and the server preserving type applications are started, these document files cannot be copied to the removable storage device connected to the client. Therefore, data cannot easily be copied, thus preventing leakage of secret information.

In the present invention, it is desirable that the second operating system program of the client can start an application program operating on the second operating system except the Web browser program only through an operation for the server preserving type application program(s) operated by a user, and sets the application program not to be started upon direct user operation therefor.

According to this configuration, even users who have a fair knowledge about computers cannot do setting changes upon operation of the client, thus preventing information leakage.

The generally-spread Web browser programs are made without consideration of the usage only in a full screen display. Therefore, a returning instruction can be performed from the full screen display. However, to prevent direct operations of the second operating system, the Web browser program of the client preferably sets an instruction for returning to a standard window screen display from a full screen display ineffective.

The client program is preferably read from a removable external storage device connected to the client. With this configuration, system changes are not necessary in the storage device of the client, and can be done in the computer of the system administrator.

Further, a rewritable nonvolatile storage device is not preferably installed in the client.

That is, the client does not include a hard disk or flash memory. Even if it is infected with a computer virus, no virus-infected data remains in the installed hard disk or flash memory, thus minimizing secondary damage of the computer virus. This rewritable nonvolatile storage device does not include a flash memory that stores BIOS (Basic Input/Output System) information, but includes a storage device that can be operable under the second operating system program (though no direct user operation is not enabled in the system of the present invention).

The Web browser program may set the URL accessed when the Web browser program is started to be read from the removable external storage device. With this configuration, the user can have a removable storage device having the set URL. Then, different URLs (may be the same URL among some users) can be accessed between the storage devices of users.

The client may be configured to execute a third procedure for starting a language input program, after the first procedure and before a user operation waiting state. That is, after the first procedure and before or after the second procedure, the Japanese language input program (for converting Kana to Kanji) or a Chinese language input program may be started.

According to the present invention, the installation of applications to be executed by the client can centrally managed by the server, thus facilitating the system management. Because data cannot be copied to the removable external storage device in the client, information leakage can be prevented beforehand.

### BRIEF DESCRIPTION OF DRAWINGS

FIG. 1 is a system block diagram of a computer system according to one embodiment.

FIG. 2 is a block diagram showing the configuration of a client and server of the computer system according to the embodiment.

FIG. 3 is a diagram conceptually showing the relationship between a server preserving program and client programs.

FIG. 4 are views each showing an example of calling a server preserving type application program, wherein FIG. 4(a) shows an example of a source file of “index.html”, FIG. 4(b) shows an example of a screen showing executed “desktop.swf” upon opening of “index.html”, and FIG. 4(c) shows an example of an executed file operational program upon clicking on a button “Filer” on the screen of FIG. 4(b).

FIG. 5 is a flow chart showing operations of the computer system according to the embodiment.

### BEST MODE FOR CARRYING OUT THE INVENTION

A first embodiment according to the present invention will now be described.

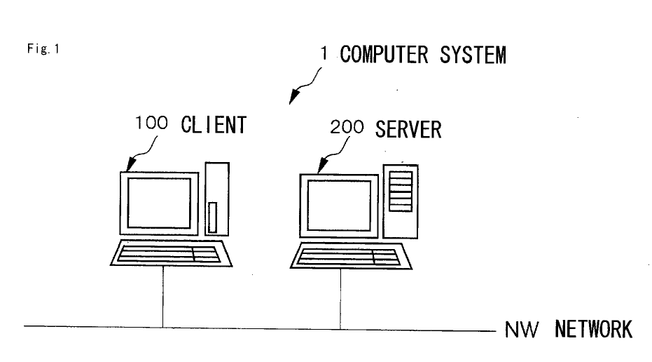

As shown in FIG. 1, a computer system 1 includes a client 100 and a server 200 which are connected with each other through a network NW. Each of the apparatuses has a communication device, and thus can perform data communications with each other by using a common protocol therebetween. In FIG. 1, only one client 100 is shown. However, at least one client 100 should be included, and generally speaking, a plurality of clients are so included as to access to the server 200. Also, a plurality of servers 200 may be connected onto a single network NW. In this case, at the time of starting the one client 100, it accesses to one server 200. However, this client 100 may access to any other servers 200 afterwards.

This accessing URL may be set for each client 100 or for each user, or all clients 100 may access to a common URL. Thereafter, a user log-in operation is requested, and users may access to different URLs.

Any suitable printer server or printer may be connected onto the network NW, as needed.

[Client 100]

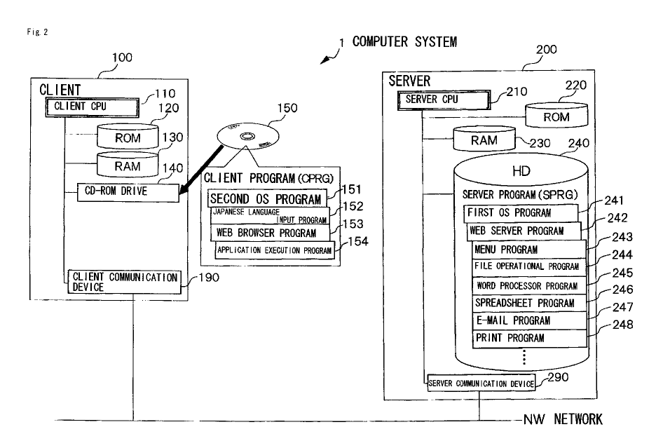

As illustrated in FIG. 2, the client 100 is so-called a personal computer capable of being connected to a LAN. The client 100 includes a client CPU 110 as a main controller, a ROM 120, a RAM 130, a CD-ROM drive 140 and a client communication device 190. Though not illustrated, an input device such as a keyboard and a mouse and an output device such as a display are connected thereto. The CD-ROM drive 140 as a client storage device, which is an external storage device, is included therein. Each user's CD-ROM 150 is loaded into the CR-ROM drive 140 at the time of activation.

<<Client CPU 110>>

The client CPU 110 is a central processing unit for executing calculation and performing temporary storage, and reads programs stored in the CD-ROM 150 serving as a storage device into the RAM 130 so as to execute them, thereby realizing various functions.

<<ROM 120>>

The ROM 120 (Read Only Memory) is a read-only storage device, and stores programs or data that are not necessarily rewritten. In this embodiment, a driver program of the CD-ROM 150 is stored in the ROM 120.

<<RAM 130>>

The RAM 130 (Random Access Memory) is a volatile semiconductor storage device. Programs are arbitrarily loaded into the RAM 130 from the CD-ROM 150 so as to be executed.

<<CD-ROM drive 140>>

The CD-ROM drive 140 is a general CD-ROM drive. In this embodiment, the CD-ROM 150 having client programs stored therein, as will be described later, are loaded into drive. By so doing, the drive 140 can serve as a unit for loading the client programs suitably into the RAM 130.

In this embodiment, the CD-ROM drive 140 has been described as an example of the client storage device that can easily configure the computer system 1. However, any other unit, for example, an optical disk, such as a DVD (Digital Versatile Disk) or Blu-ray Disk, a hard disk drive having client programs stored therein, or an externally connected MO drive (Magneto-Optical disk), may be used. If a hard disk is used as the client storage device, a virus-infected file remains in the hard disk drive when the client 100 is infected with a virus, thereby causing induction of secondary infection thereof. Therefore, it is preferred that a rewritable nonvolatile external storage device such as a hard disk drive, if possible, should not be built in the client 100. For the same reason, a rewritable flash memory except BIOS should not be built in the client 100.

In place of the CD-ROM drive 140 and the CD-ROM 150 as the client storage device, for example, a flash memory for USB connection can be used. Into this flash memory, client programs should be written. With this configuration, the portability will be better than the CD-ROM. The reading rate of this case is generally higher than the CD-ROM, thus capable of quickly starting the system. Examples of the flash memory include a standardized CF (Compact Flash) or SD memory card (Secure Digital memory card).

When the flash memory for external USB connection is used for the client storage device, a second operating system (OS) program 151 should be started from the USB-connected storage device. In order to start this program, a USB controller is stored in the ROM 120, the USB controller is read out from the ROM 120 at the time the client 100 is started, and the flash memory for USB connection should be mountable as a root device like the CD-ROM drive 140. Because a flash memory for external connection through a USB connector is rewritable, the same problem may occur as the case of the hard disk at the time of virus infection. Even if the flash memory for USB connection is infected with a virus, the virus can easily be removed, due to external connection. The virus infection could have a minimum effect if a ROM, i.e., simply an unrewritable flash memory, is used as the client storage device for USB connection.

<<Client Communication Device>>

The client communication device 190 is a device for LAN connection or Internet connection. Data transmission/reception between the client 100 and the server 200 is performed through the client communication device 190. The client communication device 190 sends and receives data to and from devices on the network NW using a common protocol, such as TCP/IP (Transmission Control Protocol/Internet Protocol), with a standardized communication system, such as Ethernet (registered trademark).

<<CD-ROM 150>>

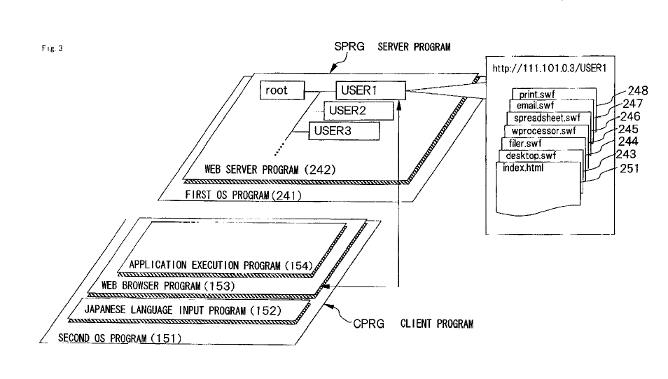

The CD-ROM 150 stores, as client programs, the second OS program 151, a Japanese language input program 152, a Web browser program 153 and an application execution program 154. These client programs CPRG are configured as shown in FIG. 3. That is, the Japanese language input program 152 and the Web browser program 153 operate on the second OS program 151, while the application execution program 154 operates on the Web browser program.

<<Client Program CPRG>>

<Second OS Program 151>

The second OS program 151 is a general operating system. That is, the program is to provide basic functions that are commonly used by much application software and that include an input/output function such as the input through keyboard or the output on the display, and to manage the entire computer system including the disk or memory, etc. Examples of the operating system include Windows (registered trademark), MacOS (registered trademark), UNIX (registered trademark) and Linux (registered trademark).

As will be described later, to avoid direct user operation of functions of the second OS program 151 in the client 100 of the present invention, it is desired to set all ineffective shortcut commands of the second OS program 151 through the keyboard, particularly, commands for starting, stoppage or switching of application. On the other hand, it is desired to set an effective copy command for storing character data or image data on a clipboard (a predetermined area for temporarily storing data in the RAM 130) and an effective paste command for reading data stored on the clipboard.

<Japanese Language Input Program 152>

The Japanese language input program 152 is a language input program for converting Kana to Kanji in order to input the Japanese language, and any known Japanese language input program can be used. The Japanese language input program 152 operates on the second OS program 151. The Japanese language input program 152 is not necessary if the computer system is only for the English language. For any country using characters other than the alphabets, and for the client using any language other than the Japanese language, a character input program corresponding to the target country should be prepared. For example, for the Chinese language, a Chinese language input program is prepared, while a Korean input program is prepared for the Korean language.

Note that other programs operating on the second OS program may, for example, include a program for browsing a PDF (Portable Document Format) file.

<Web Browser Program 153>

The Web browser program 153 operates on the second OS program 151, and is application software for browsing documents (web pages) described in HTML, or the like, and any known web browser program can be used. The Web browser program 153 requests a computer of a specified URL for an HTML file, or the like, receives the file, and displays the file on the display after analyzing its layout. In this embodiment, the Web browser program 153 is automatically started without waiting for a user operation, after having started the second OS program 151. That is, an execution file of the Web browser program 153 simply needs to be described in a batch file, shell script, log-in script, start-up folder, or the like each of which describes a series of programs that are executed at the activation of the second OS program 151.

At the activation, a URL to be accessed (so-called a homepage) by the Web browser program 153 is set in advance for each client or user, and is stored in the CD-ROM 150. The window at the activation is set in a full screen display. According to one method for this setting, when setting with Internet Explorer (registered trademark) ver. 6.0 on Windows (registered trademark) 2000, a shortcut file is created, and a link destination of the shortcut file is set as “C¥ProgramFiles¥Internet Explorer¥IEXPLORE.EXE-k http://111.101.0.3/USER1/index.html”. As a result, the file of “http://111.101.0.3/USER1/index.html” can be displayed in a full screen display.

The URL of this access destination is set for each user or client. When it is set for each user, a link destination (URL) given for each user should simply be set as the link destination of the shortcut file which is called at the activation within the CD-ROM held by each user. The same applies to the case where each user holds the flash memory for USB connection. When it is set for each client, the client 100 is started from the hard disk, and one link destination should simply be set as a link destination which is in the hard disk for starting the client and for the shortcut file for calling.

For the computer system 1 of the present invention, the Web browser program 153 corresponds to a platform on which various server preserving type application programs as will be described later are executed. This is provided for preventing the user from easily operating functions of the second OS program 151 directly and preventing data from being copied onto a removable external storage device to be connected to the client 100.

Therefor, it is desired to ineffectively set the operation for returning from the full screen display of the Web browser program 153 to the standard window screen display. Note that the standard window screen display is a display format for displaying visible window frames in the display. Needless to say, it is preferred that the menu of the Web browser program 153 itself be set as undisplayable.

<Application Execution Program 154>

The application execution program 154 is so-called plug-in software. This program operates on the Web browser program 153, and enables display of an image of GUI, or the like, in the window (in the full screen display in this embodiment) of the Web browser, and execution of various scripts specified in response to an operation, such as clicking on a GUI object displayed on the image.

The server preserving type application programs executed by the application execution program 154 are stored in the server 200 as will be described later, and are called by the client 100 in response to a request from the Web browser program 153 so as to be executed on the Web browser program 153.

The server preserving type application programs may, for example, be Flash (registered trademark) which has been developed by Macromedia in combination of a voice and vector graphics animation, or java applet which uses java that is a program language developed by Sun Microsystems Inc.

The application execution program 154 is introduced in the Web browser program 153, as plug-in software for enabling Flash or java (registered trademark) to be executed on the browser.

In this embodiment, the server preserving type application programs as will be described later display child windows in the Web browser window (a full screen display in this case). Various applications using GUI are configured in the child windows. Upon execution of the server preserving type application programs in accordance with the application execution program, the child windows of various applications are displayed in the Web browser window, and the applications are executed in the child windows. These child windows are not necessary, and instead, a button or the like, as a GUI object may be displayed directly on the Desktop so as to have necessary functions for this button.

[Server 200]

The server 200 may be configured using a general computer, and includes a server CPU 210 as a main controller like the client CPU, a ROM 220 as a read-only storage device, a RAM 230 as a volatile semiconductor storage device, a server communication device 290 for performing data communication with the client 100 through the network NW, and a hard disk (HD) 240 as an external storage device.

<<Hard Disk 240>>

The hard disk 240 stores, as server programs SPRG, a first OS program 241, a Web server program 242, a menu program 243, and a file operational program 244 as server preserving type application program, a word processor program 245, a spreadsheet program 246, an e-mail program 247 and a print program 248. As shown in FIG. 3, of these server programs SPRG, the Web server program 242 operates on the first OS program 241. Of the Web server program 242, the server preserving type application programs are stored in a root directory as a home directory of the URL managed by itself and in each user's directory (URL) USER 1, USER 2, USER 3, . . . that are in a lower level than the root directory.

As illustrated in FIG. 3, each user's directory stores server preserving application type application programs, such as “index.html” (251) to be called first from the Web browser program 153, and “desktop.swf” (243), “filer.swf” (244), “wprocessor.swf” (245), “spreadsheet.swf” (246), “email.swf” (247) and “print.swf” (248) that are for realizing various applications using the GUI.

As like the second OS program 151, the first OS program 241 is to provide basic functions that are commonly used by a lot of application software and that include an input/output function such as the input through keyboard or the output on the display, and to manage the entire computer system including the disk or memory, etc.

The Web server program 242 is a program that operates on the first OS program 241, and is a server program that distributes, for example, an html file indicated in a predetermined URL requested from the Web browser program 153 of a computer connected onto the network NW. Any known program may be used for this program 242.

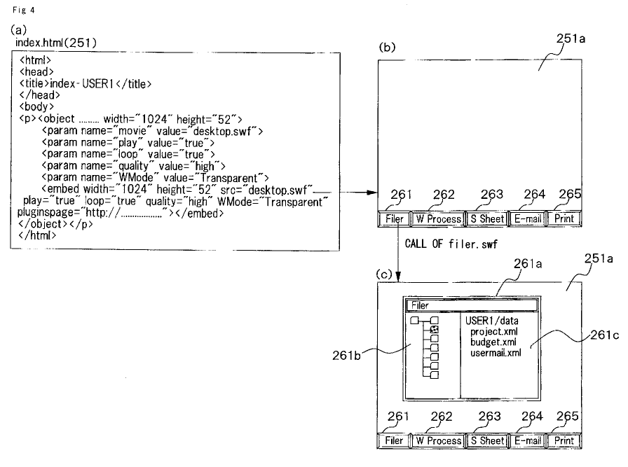

FIG. 4 are views each showing an example of a call for the server preserving type application program. FIG. 4(a) shows an example of a source file of “index.html”, FIG. 4(b) shows an example of a screen showing an opened “index.html” and an executed “desktop.swf”, and FIG. 4(c) shows an example showing a file operational program upon clicking on a button “Filer” on the screen of FIG. 4(b).

As described above, the server preserving type application programs are called by the Web browser program 153. Also, the programs are to display an image in the Web browser and to define various functions in accordance with an operation for the image. As shown in FIG. 2, some examples of the server preserving type application programs include the menu program 243, the file operational program 244, the word processor program 245, the spreadsheet program 246, the e-mail program 247 and the print program 248.

These server preserving type application programs respectively correspond to files of the same numerals shown in FIG. 3.

For example, the menu program 243 corresponds to “desktop.swf” (243) shown in FIG. 3, and is called in “index.html” which is called at the activation of the Web browser program 153 as shown in FIG. 4(a). Under the program of “desktop.swf” (243), buttons 261 to 265, including images for calling various applications in a window 251a of the Web browser in the full screen display, are displayed, as exemplarily shown in the lower section of the screen of FIG. 4(b). The button 261 indicated by “Filer” is defined to call “filer.swf” (244) in response to its clicking operation using a pointer (not illustrated). Similarly, the button 262 indicated by “W Process” is defined to call “wprocessor.swf” in response to its clicking operation, the button 263 indicated by “S Sheet” is defined to call “spreadsheet.swf” in response to its clicking operation, the button 264 indicated by “E-mail” is defined to call “email.swf” in response to its clicking operation, and the button 265 indicated by “Print” is defined to call “print.swf” in response to its clicking operation.

Upon clicking on the button 261 indicated by “Filer”, the file operational program “filer.swf” is called and executed by the client 100. Then, a child window 261a is displayed in the window 251a. The child window 261a displays a screen 261b showing folders in tree structures, and displays also a screen 261c showing the contents of a specified holder. As exemplarily shown in the screen 261c, the data used on the server 200 may, for example, be an xml file, but is not limited to the xml file. Any suitable data format can be adapted in accordance with the configuration of the server preserving type application program.

A file that is displayed by this file operational program 244 and can be copied or moved by the user is limited within a predetermined folder of the server 200. It is set that the user is not access to the removable external storage device to be connected to the client 100 that is used by at least one user. By doing so, the user can not copy and take out data by connecting the removable external storage device to the client 100.

The e-mail program 247 would be impractical, unless it can transmit data with an attached file, like generally used e-mail programs do. Also in the computer system of the present invention, a file is preferably attached to an email. In this manner, the administrator can easily check a file attached to an email so as to be transmitted. Therefore, the data would not easily be taken out by the user, by informing the user that the administrator monitors the transmission.

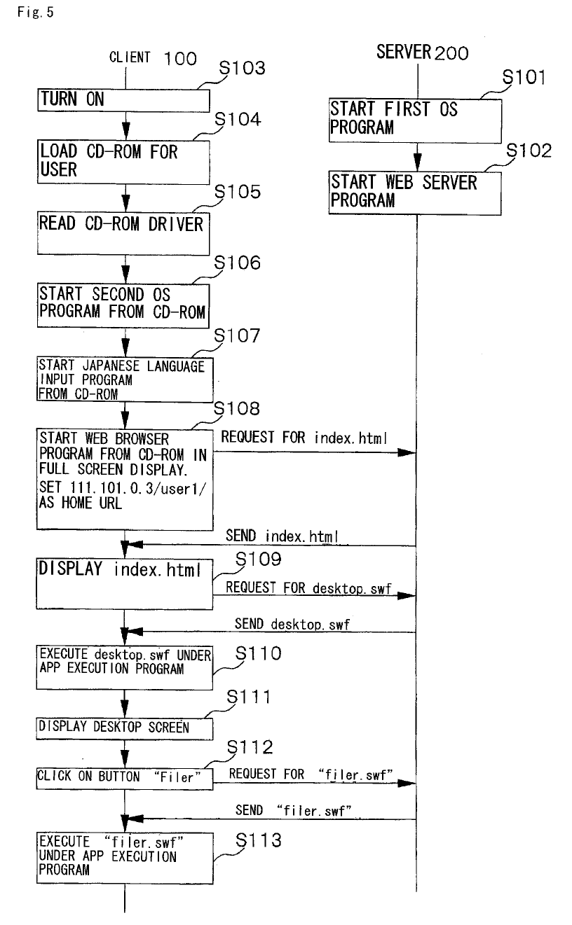

Operations of the computer system 1 having the above configuration will now be described with reference to the flowchart of FIG. 5.

The server 200 is turned on so as to start the first OS program 241 (S101). The Web server program 242 is started (S102) so as to set any files ready to be transmitted any time in response to a request from the client 100.

The client 100 is turned ON (S103), and the CD-ROM prepared for each user is loaded into the CD-ROM drive 140 (S104). Then, the client 100 reads the CD-ROM driver from the ROM 120 (S105), and reads the second OS program 151 from the CD-ROM 150 so as to start the program (S106). Further, the client 100 reads the Japanese language input program 152 from the CD-ROM 150 so as to start the program (S107).

Then, the client 100 reads the Web browser program 153 from the CD-ROM 150 so as to start the program. At this time, the client displays the Web browser in a full screen display in accordance with its setting, and requests the server 200 for a file “index.html” within “http://111.101.0.3/USER1/” corresponding to a user's homepage (the first access destination) that is set in the CD-ROM 150 (S108).

In response to the request from the client 100, the server 200 distributes the file “index.html” from the directory “http://111.101.0.3/USER1/” to the client 100, and displays “index.html” on the client 100. At this time, “index.html” is defined to call a menu program “desktop.swf”, thereby the client 100 requests the server 200 for “desktop.swf” (see FIG. 4(a)).

In response to the request from the client 100, the server 200 distributes the file “desktop.swf” from the directory “http://111.101.0.3/USER1/” to the client 100. Then, the client 100 executes “desktop.swf” in accordance with the application (APP) execution program 154 (S110), and displays the menu buttons 261 to 265 in the Web browser window (due to the full screen display, it is the same as the display of the client 100) (S111, see FIG. 4(b)).

The above operations for starting the client 100 are a series of operations. There is no room for any user operation between S105 to S111. That is, the user can not be aware of the Web browser window. More specifically, when the client 100 is started, it seems as if only the menu buttons 261 to 265 displayed in the lower section can be used. As long as operations are set ineffective so that the second OS program 151 can not directly be operated through a shortcut key, etc., the user can use only the functions displayed on the activation screen exemplarily shown in FIG. 4(b). Even if the direct operations for the second OS program 151 are not set ineffective, the general user cannot usually operate any hidden functions that are not displayed on the screen. Eventually, the general user can execute only the application(s) in accordance with the server preserving type application programs provided mainly from the server 200.

If the user clicks on the button “Filer” 261 (S112) a request for calling “filer.swf” defined by the button 261 is sent to the server 200. In response to this request, the server 200 distributes the file “filer.swf” to the client 100. The client 100 executes “filer.swf” in accordance with the application execution program 154, and thus can use the file operational program 244, like the child window 261a exemplarily shown in FIG. 4(c).

Because thus provided file operational program 244 sets the removable external storage device connected at least to the client 100 inaccessible, an easy-data-leakage can be prevented beforehand.

According to such a computer system 1 of the present invention, the following effects can be accomplished.

Because the applications used by the client 100 and user data are centrally arranged in the server 200 (this server 200 is not limited to one single server), the installation and updating of the applications can be done at the server 200; thus, easily managing the system. Because the user data also is not placed in the client 100, it can be monitored. That is, any unauthorized making of data or bringing up of data can be monitored.

The applications may be installation only to the server 200, thus reducing the burden at the introduction.

As described above, the accessible range of the file operational program 244 is so limited that the removable external storage device connected at least to the client 100 is set inaccessible. As a result, data can be prevented from being easily taken out.

Further, within the second OS program 151, the application programs (not including the Japanese language input program 152 and a browsing program for the PDF file) other than the Web browser program 153 can executed only through operations in accordance with the server preserving type application programs, and such application programs is set not to be started upon direct user operations for the second OS program. As a result, the above-described data leakage can securely be prevented.

A configuration is made such that the client program CPRG is read from the removable external storage device connected to the client and particularly a rewritable nonvolatile storage device is not installed in the client 100. According to this configuration, even if a computer virus trespassing into the client 100, secondary infection of the virus can be prevented because no virus-infected file remains in the client 100.

The embodiment of the present invention has thus been described. The present invention is not limited to the above-described embodiment, and can be executed by making changes thereto.

For example, the embodiment is configured such that the file of the server preserving type application program has been stored in each user-accessing folder. However, a common file of the server preserving type application program may be stored in the common folder so that a part of users or all users may access to the file. At this time, a configuration file customized for each user or user document data may be stored in a folder provided for each user, and may be read from the common server preserving type application program.

What is claimed is:

1. A centralized management type computer system comprising at least one server and at least one client, wherein
the server includes a server CPU, a server storage device and a server communication device, and has a server program, which is executed by the server CPU, in the server storage device;
the server program includes:
a first operating system program,
a Web server program which operates on the first operating system program, causes the server to function as a Web server, and sends a file or files indicated by one or a plurality of URL and set in the server storage device through the server communication device in response to a request from the client, and
various server preserving type application programs which are program files indicated by the URL, and realize various applications using a GUI operating in response to a call by a Web browser on the client;
the client includes a client CPU, a client storage device and a client communication device, and a client program, which is executed by the client CPU, in the client storage device;
the client program includes:
a second operating system program,
a Web browser program which operates on the second operating system program, and it accesses to a file or files indicated by a predetermined URL in the server storage device through the client communication device, and
an application execution program which is executed in a Web browser window displayed upon execution of the Web browser program, and executes the server preserving type application programs so as to realize various applications using the GUI; and
the client executes a first procedure for starting the second operating system program and a second procedure for starting the Web browser program with the file indicated by the URL serving as an access destination in a full screen display without waiting for a user operation, thereby starting the server preserving type application program(s) indicated by the URL at activation of the client.

2. The centralized management type computer system according to claim 1, wherein
the various applications using the GUI include a file operational application for performing at least a copy operation for a file, and the file operational application is set to be capable of operating a file in a predetermined folder of the server storage device, and is set to be incapable of accessing to a removable external storage device which is capable to be connected at least to the client.

3. The centralized management type computer system according to claim 1, wherein
the second operating system program of the client is capable of starting an application program operating on the second operating system except the Web browser program only through an operation for the server preserving type application program(s) operated by a user, and sets the application program not to be started upon direct user operation therefor.

4. The centralized management type computer system according to claim 1, wherein
the Web browser program of the client sets an instruction for returning to a standard window screen display from a full screen display ineffective.

5. The centralized management type computer system according to claim 1, wherein
the client program is read from a removable external storage device connected to the client.

6. The centralized management type computer system according to claim 5, wherein
a rewritable nonvolatile storage device is not installed in the client.

7. The centralized management type computer system according to claim 1, wherein
the Web browser program sets the URL accessed to be read from a removable external storage device when the Web browser program is started.

8. The centralized management type computer system according to claim 1, wherein
the client executes a third procedure for starting a language input program, after the first procedure and before a user operation waiting state.
